(19) United States
(12) Patent Application Publication
(10) Pub. No.: US 2017/0073815 A1
(43) Pub. Date: Mar. 16, 2017

(54) METHOD FOR A NON-AQUEOUS ELECTROLESS POLYOL DEPOSITION OF METAL OR METAL ALLOY IN FEATURES OF A SUBSTRATE

(71) Applicant: Lam Research Corporation, Fremont, CA (US)

(72) Inventors: Mehul N. Patel, Austin, TX (US); Diane Hymes, San Jose, CA (US); Yezdi Dordi, Palo Alto, CA (US); Aniruddha Joi, San Jose, CA (US)

(21) Appl. No.: 14/850,199

(22) Filed: Sep. 10, 2015

(51) Int. Cl. C23C 18/16; B05D 1/00; C23C 18/40

(52) U.S. Cl. CPC C23C 18/1603; C23C 18/40; C23C 18/166; C23C 18/1676; C23C 18/1687; B05D 1/005; C23C 18/1651

(57) ABSTRACT

A method for depositing metal or metal alloy on a substrate includes preparing a mixture including a hydroxide, a polyol solvent, a metal precursor and a complexing agent, wherein the mixture does not include water; applying the mixture to a substrate including exposed metal surfaces to selectively deposit metal onto the exposed metal surfaces of the substrate; and heating the mixture to a predetermined deposition temperature range from 120° C. and 160° C. at least one of before or after applying the mixture to the substrate.

### FIELD

The present disclosure relates to substrate processing, and more particularly to a method for non-aqueous electroless polyol deposition in features of a substrate.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Processing of substrates such as semiconductor wafers may involve metallization over features such as vias and trenches. A current approach for copper (Cu) metallization within features includes two steps. In a first step, a Cu seed layer is deposited using physical vapor deposition (PVD) on a metal liner such as titanium (Ti), tantalum (Ta), ruthenium (Ru), cobalt (Co), etc. In a second step, the features are filled by electrodeposition of Cu from an aqueous solution.

As feature sizes shrink, the seed layer becomes more difficult to deposit using PVD. Challenges include seed overhang, poor sidewall coverage, asymmetric growth, voids, pinch-off, and/or discontinuities. The seed layer can also limit the available space for electroplating. Bypassing the PVD seed layer process by directly electroplating on the metal liner is difficult due to poor nucleation of Cu on the metal liner.

Challenges that arise from feature filling with conventional water-based electroless processes are incompatibility of the electronegative metals (such as manganese (Mn), aluminum (Al), titanium (Ti), tantalum (Ta), and cobalt (Co)) in water-based plating solutions. Typical electroless processes are also difficult to scale due to the instability of the external reducing agents that have a limited shelf-life and long induction times.

### SUMMARY

A method for depositing metal or metal alloy on a substrate includes preparing a mixture including a hydroxide, a polyol solvent, a metal precursor and a complexing agent, wherein the mixture does not include water; applying the mixture to a substrate including exposed metal surfaces to selectively deposit metal onto the exposed metal surfaces of the substrate; and heating the mixture to a predetermined deposition temperature range from 120° C. and 160° C. at least one of before or after applying the mixture to the substrate.

In other features, the method includes preparing a first solution including the hydroxide and the polyol solvent; preparing a second solution including the metal precursor, the complexing agent and the polyol solvent; and mixing the first solution and the second solution. The metal precursor includes at least one precursor selected from a group consisting of a copper precursor, a ruthenium precursor, a cobalt precursor, a platinum precursor, and a manganese precursor. The metal precursor is selected from a group consisting of copper(II) chloride (CuCl₂), copper(II) sulfate (CuSO₄), or copper(II) hydroxide (Cu(OH)₂). The hydroxide is selected from a group consisting of sodium hydroxide (NaOH) and potassium hydroxide (KOH).

In other features, the complexing agent is selected from a group consisting of an ionic liquid and an organic complex. The ionic liquid is selected from a group consisting of 1-butyl-3-methylimidazolium tetrafluoroborate and 1-butyl-3-methylimidazolium acetate. The organic complex is selected from a group consisting of 2,2′-bipyridyl and ethylenediaminetetraacetic acid (EDTA).

In other features, the method includes removing the substrate from the mixture after a predetermined deposition period. The method includes rinsing and drying the substrate. The rinsing includes rinsing the substrate with at least one of deionized water and a polyol solvent and wherein the drying includes exposing the substrate to molecular nitrogen gas. Applying the mixture includes immersing the substrate in the mixture. Applying the mixture includes using a spin-on approach to apply the mixture to the substrate.

A method for depositing metal or metal alloy on a substrate includes preparing a first solution including a hydroxide and a polyol solvent; applying the first solution to a substrate including exposed metal surfaces; heating the first solution to a first predetermined temperature at least one of before or after applying the solution to the substrate; preparing a second solution including a metal precursor, a complexing agent and a polyol solvent; heating the second solution to a second predetermined temperature; and applying the second solution to the substrate to selectively deposit metal onto the metal surfaces of the substrate. The first predetermined temperature and the second predetermined temperature are in a range from 120° C. and 160° C.

In other features, the metal precursor includes at least one precursor selected from a group consisting of a copper precursor, a ruthenium precursor, a platinum precursor, a cobalt precursor and a manganese precursor. The metal precursor is selected from a group consisting of copper(II) chloride (CuCl₂), copper(II) sulfate (CuSO₄), or copper(II) hydroxide (Cu(OH)₂). The hydroxide is selected from a group consisting of sodium hydroxide (NaOH) and potassium hydroxide (KOH).

In other features, the complexing agent is selected from a group consisting of an ionic liquid and an organic complex. The ionic liquid is selected from a group consisting of 1-butyl-3-methylimidazolium tetrafluoroborate and 1-butyl-3-methylimidazolium acetate. The organic complex is selected from a group consisting of 2,2′-bipyridyl and ethylenediaminetetraacetic acid (EDTA).

In other features, the method includes removing the substrate after a predetermined deposition period. The method includes rinsing and drying the substrate. The rinsing includes rinsing the substrate with at least one of deionized water and a polyol solvent and the drying includes exposing the substrate to molecular nitrogen gas.

In other features, applying the first solution includes immersing the substrate in the first solution and applying the second solution includes adding the second solution to the first solution while the substrate is immersed in the first solution. Applying the first solution to the substrate includes using a spin-on approach and applying the second solution to the substrate includes using the spin-on approach.

A method for depositing metal or metal alloy on a substrate includes preparing a first solution including a metal precursor, a hydroxide and a polyol solvent; applying the first solution to a substrate including exposed metal surfaces; heating the first solution to a first predetermined temperature at least one of before or after applying the first solution to the substrate; preparing a second solution including a complexing agent and a polyol solvent; heating the second solution to a second predetermined temperature; and applying the second solution to the substrate to selectively deposit metal onto the exposed metal surfaces of the substrate. The first predetermined temperature and the second predetermined temperature are in a range from 120° C. and 160° C.

In other features, the metal precursor includes at least one precursor selected from a group consisting of a copper precursor, a ruthenium precursor, a platinum precursor, a cobalt precursor and a manganese precursor. The metal precursor is selected from a group consisting of copper(II) chloride (CuCl₂), copper(II) sulfate (CuSO₄), or copper(II) hydroxide (Cu(OH)₂). The hydroxide is selected from a group consisting of sodium hydroxide (NaOH) and potassium hydroxide (KOH). The complexing agent is selected from a group consisting of an ionic liquid and an organic complex. The ionic liquid is selected from a group consisting of 1-butyl-3-methylimidazolium tetrafluoroborate and 1-butyl-3-methylimidazolium acetate. The organic complex is selected from a group consisting of 2,2′-bipyridyl and ethylenediaminetetraacetic acid (EDTA).

In other features, the method includes removing the substrate after a predetermined deposition period. The method includes rinsing and drying the substrate. The rinsing includes rinsing the substrate with at least one of deionized water and polyol solvent and the drying includes exposing the substrate to molecular nitrogen gas.

In other features, applying the first solution includes immersing the substrate in the first solution and applying the second solution includes mixing the second solution with the first solution while the substrate is immersed in the first solution. Applying the first solution to the substrate includes using a spin-on approach and applying the second solution to the substrate includes using the spin-on approach.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1A and 1B illustrate an example of a substrate including features that are filled with metal according to the present disclosure;

FIGS. 2A and 2B illustrate another example of a substrate including features that are filled with metal according to the present disclosure;

FIGS. 3A-3D illustrate an example of a process for filling of features with metal according to the present disclosure;

FIG. 4 illustrates an example of a spin-on process for filling of features with metal according to the present disclosure;

FIGS. 5A and 5B are examples of flowcharts of methods for filling of features of a substrate with metal according to the present disclosure;

FIGS. 6A and 6B are examples of flowcharts of methods for filling of features of a substrate with metal according to the present disclosure; and

FIGS. 7A and 7B are examples of flowcharts of methods for filling of features of a substrate with metal according to the present disclosure.

In the drawings, reference numbers may be reused to identify similar and/or identical elements.

### DETAILED DESCRIPTION

The present disclosure relates to a method for selectively depositing metal such as copper (Cu) inside features including a metal or metal alloy liner using a non-aqueous solvent (no external water added) and no external reducing agent. In some examples, an electroless deposition solution includes a metal precursor, a hydroxide, a complexing agent and a polyol solvent. In some examples, the metal precursor includes a copper (Cu) precursor and the complexing agent combines with the Cu ions in solution. In some examples, the Cu complex is subsequently reduced by the solvent and selectively deposits on the metal surface.

Using the non-aqueous method according to the present disclosure enables feature fill using a simple solution within a shorter period than the typical two-step physical vapor deposition (PVD) and electrochemical deposition (ECD) process. The method according to the present disclosure utilizes a polyol process for deposition.

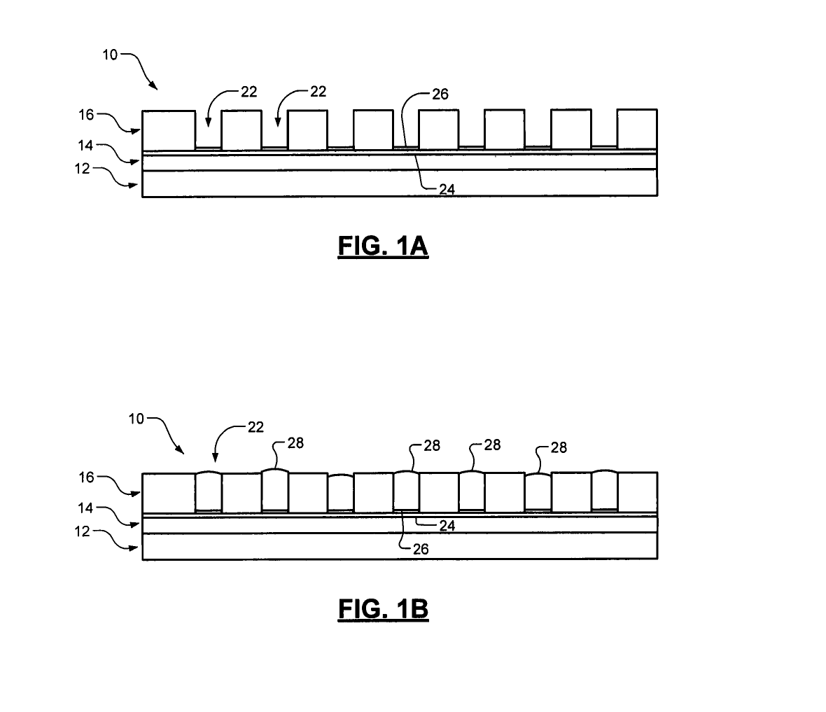

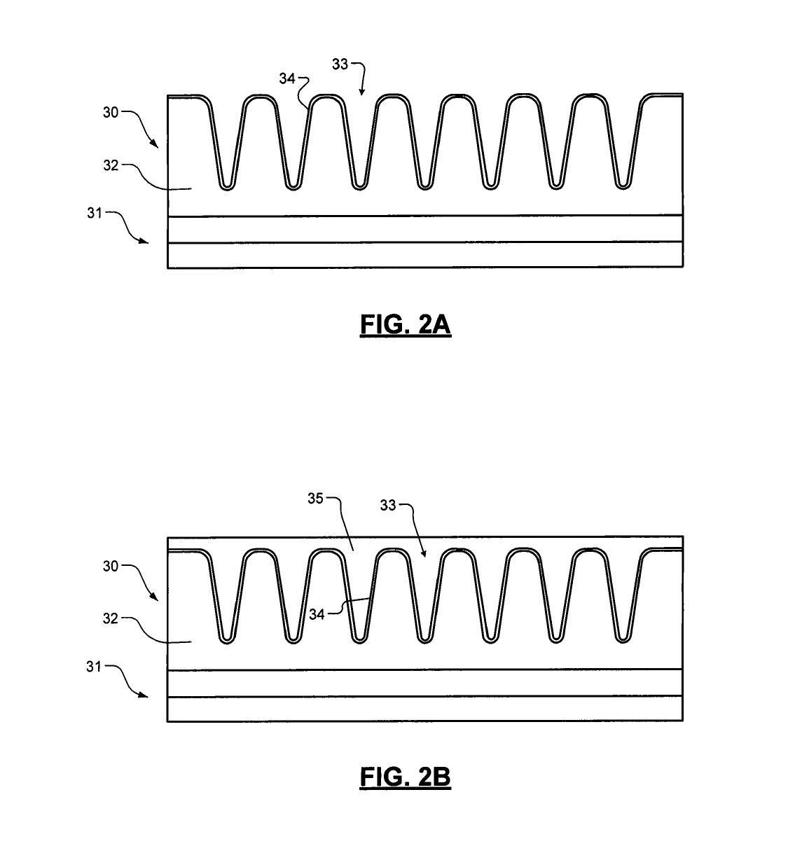

Referring now to FIG. 1, a substrate 10 is shown. While a specific example of a substrate is shown, skilled artisans will appreciate that other types of substrates may be used. The substrate 10 includes a silicon layer 12, a buried oxide (BOX) layer 14, and a patterned oxide layer 16. The patterned oxide layer 16 defines features 22 such as trenches or vias. The substrate 10 includes a tantalum layer 24 and a metal liner 26 located at the bottom of the features 22. In some examples, the metal liner 26 includes ruthenium (Ru) or cobalt (Co), although other materials can be used.

Prior to deposition, the substrate may be cleaned. In some examples, the substrate is cleaned using sodium borohydride (NaBH₄) or polyol solvent. Then, one of the processes described below is performed to fill the features 22 with metal 28.

Referring now to FIG. 2, another example of a substrate 30 is shown, the substrate 30 includes one or more underlying layers 31, an oxide layer 32 defining features 33, and a metal liner 34. One of the processes described below is performed to fill the features 33 with metal 35.

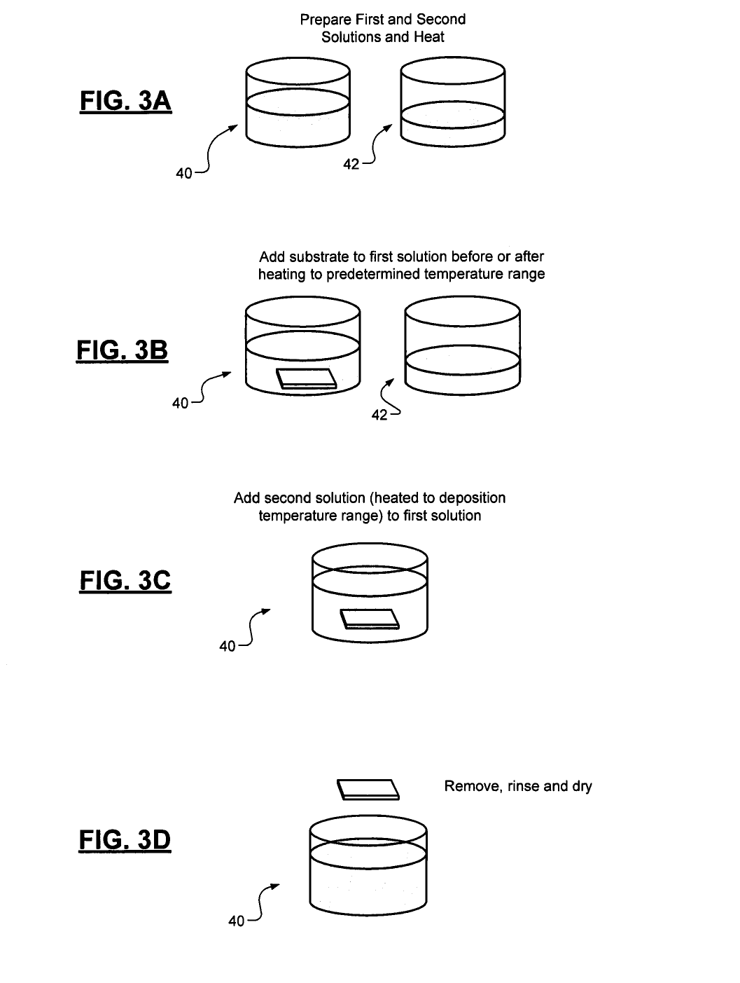

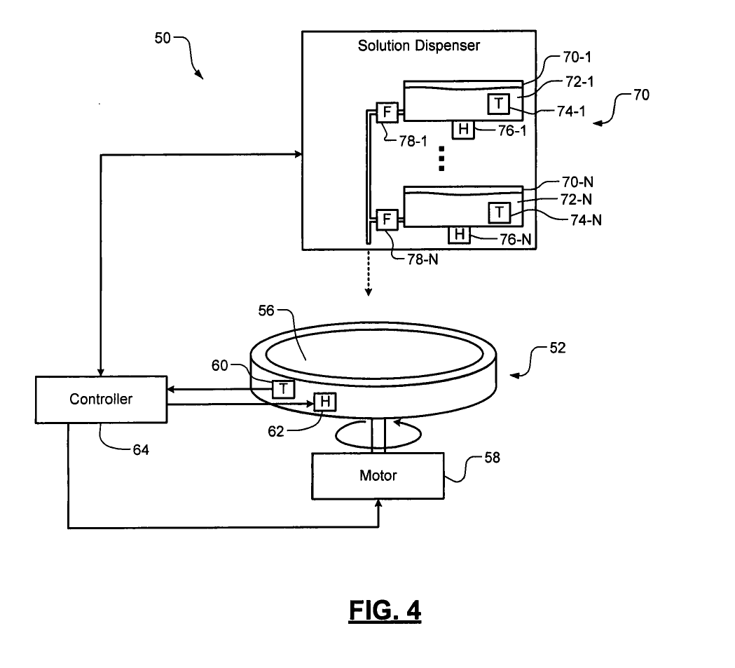

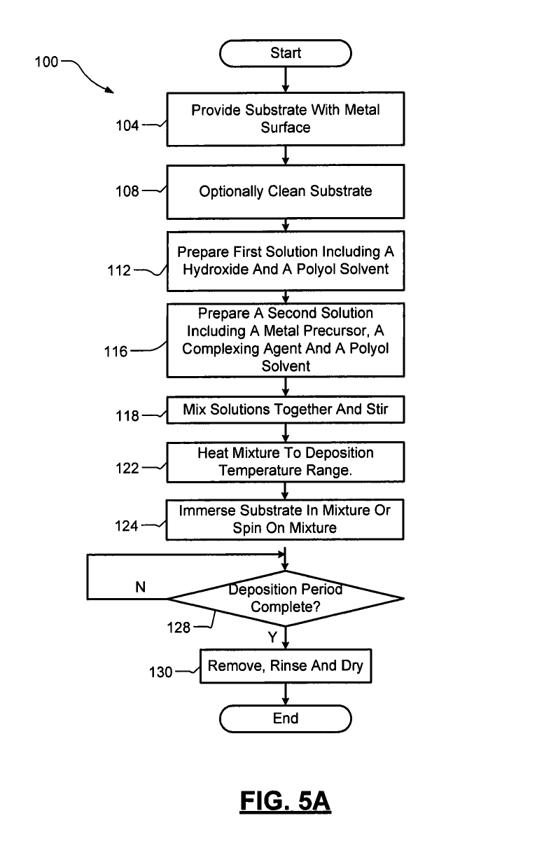

Referring now to FIGS. 3A-3D, various stages during deposition are shown. In FIG. 3A, a first solution is prepared using a metal precursor, a hydroxide and a polyol solvent. In some examples, the metal precursor includes a copper (Cu), ruthenium (Ru), platinum (Pt), cobalt (Co) and/or manganese (Mn) precursor. In some examples, the copper precursor may include copper(II) chloride (CuCl₂), copper(II) sulfate (CuSO₄), or copper(II) hydroxide (Cu(OH)₂). In some examples, the hydroxide includes sodium hydroxide (NaOH) or potassium hydroxide (KOH). In some examples, the polyol solvent includes ethylene glycol.

A second solution is prepared with a complexing agent and a polyol solvent. In some examples, the complexing agent includes an ionic liquid. In some examples, the ionic liquid includes 1-butyl-3-methlimidazolium tetrafluoroborate or 1-butyl-3-methylimidazolium acetate. In other examples, the complexing agent includes an organic complex such as 2,2′-bipyridyl or ethylenediaminetetraacetic acid (EDTA).

During the process, the first and second solutions are heated to a deposition temperature in a deposition temperature range. In some examples, the deposition temperature range is greater than or equal to 120° C. and less than or equal to 160° C. In some examples, the deposition temperature range is from 130 to 150° C.

In some examples, the first and second solutions are mixed and the substrate is exposed to the mixture either before or after heating to the predetermined temperature range. In other examples, the substrate is initially exposed to the first solution before or after heating to the first solution to the predetermined temperature range and then to a mixture of the first and second solutions. While the following discussion describes heating the first and second solutions to the same or different temperatures during processing, the deposition can be performed with the first and second solutions at any temperature in the deposition temperature range.

In an example shown in FIG. 3B, a substrate is immersed in the first solution before or after heating the first solution and/or the substrate to the predetermined temperature range. In FIG. 3C, the second solution is heated and added to the first solution to initiate metal deposition on the substrate in the predetermined deposition temperature range. In FIG. 3D, after a deposition period is complete, the substrate is removed, rinsed and dried.

In some examples, deposition according to the present disclosure is a one-step process as compared to the conventional PVD/ECD process. Deposition according to the present disclosure directly and selectively deposits metal on the metal surfaces and eliminates the need for a seed layer deposition step. The non-aqueous process according to the present disclosure prevents surface oxidation of the metal liner (e.g. Ru or Co liner). As a result, the PVD/ECD fill process does not need to be used.

The present disclosure uses a polyol process at a relatively low temperature range. The polyol process has been performed using Cu at higher temperatures (>180° C.) and homogenously produces metal nanoparticles in solution. The present disclosure operates at a lower temperature range (e.g., 120° C.<=T<=160° C.) at which homogenous nucleation does not occur. Nucleation is confined/directed to metal surfaces of the substrate (such as a metal liner) thus providing for process selectivity.

In some examples, ionic liquids are used as a complexing agent for the metal precursor. However, more common complexing agents such as 2,2′-bipyridyl or ethylenediaminetetraacetic acid (EDTA) may also be used. The use of the polyol solvent as a reducing agent eliminates the need for an external reducing agent thus reducing process complexity and providing for a relatively long shelf life. Using this non-aqueous method, metals such as Cu can also be deposited on electronegative metals that are prone to oxidation in aqueous media. In addition to Cu, the method according to the present disclosure may be used to deposit metals such as ruthenium (Ru), platinum (Pt), manganese (Mn), cobalt (Co) or copper manganese (CuMn). While a specific example is described above, there are many variations of the foregoing process, some of which are described further below.

Referring now to FIG. 4, a spin-on deposition system 50 may be used. The spin-on deposition system 50 includes a substrate support 52 for supporting a substrate 56. A motor 58 may be used to rotate or spin the substrate support 52. A temperature sensor 60 and a heater 62 may be used in conjunction with a controller 64 to monitor a temperature of the substrate support 52 and/or the substrate 56 during deposition. The temperature of the substrate may be set to a temperature in the predetermine temperature range using the heater. The controller 64 may also be used to control the motor 58 and a solution dispenser 70.

In some examples, the solution dispenser 70 includes fluid containers 70-1, 70-2, . . . and 70-N (collectively fluid containers 70) storing solutions 72-1, 72-2, . . . and 72-N (collectively solutions 72), respectively. Temperature sensors 74-1, 74-2, . . . and 74-N (collectively temperature sensors 74) and heaters 76-1, 76-2, . . . and 76-N (collectively heaters 76) may be used to control a temperature of the solutions 72-1, 72-2, . . . and 72-N, respectively. Flow control devices 78-1, 78-2, . . . and 78-N (collectively flow control devices 78) such as valves and/or mass flow controllers (MFCs) may be used to control delivery of the solutions 72. In some examples, N=2 and the solution dispenser 70 dispenses the first and second solutions as needed.

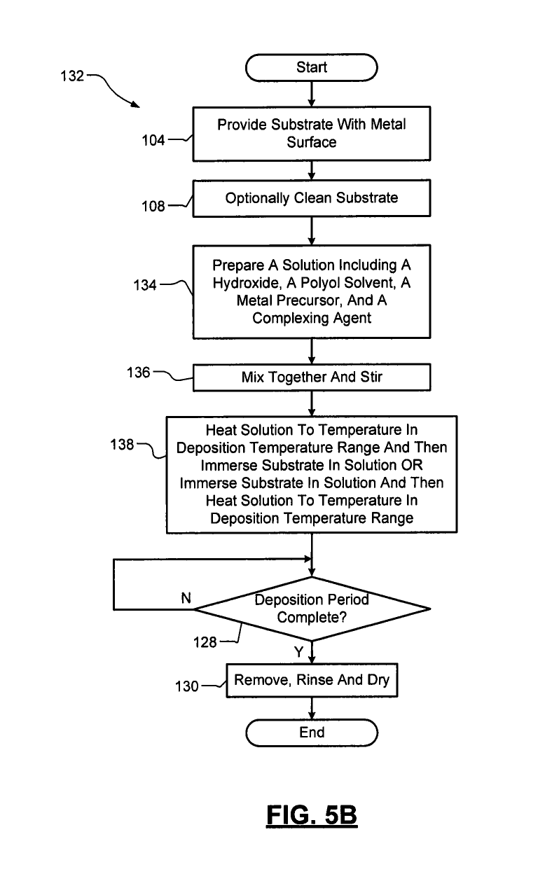

Referring now to FIG. 5A, a method 100 for depositing metal is shown. At 104, a substrate is provided with exposed metal or metal alloy surfaces such as a metal liner. The metal surfaces may be arranged in features such as trenches or vias. At 108, the substrate is optionally cleaned. At 112, a first solution is prepared. The first solution includes a hydroxide and a polyol solvent. In some examples, the hydroxide includes sodium hydroxide (NaOH) or potassium hydroxide (KOH). In some examples, the polyol solvent includes ethylene glycol.

At 116, a second solution is prepared. The second solution includes a metal precursor, a complexing agent and a polyol solvent. In some examples, the metal precursor includes a Cu, Ru, Pt, Mn, and/or Co precursor. In some examples, the copper precursor may include copper(II) chloride (CuCl₂), copper(II) sulfate (CuSO₄), or copper(II) hydroxide (Cu(OH)₂).

In some examples, the complexing agent includes an ionic liquid or organic complex. In some examples, the ionic liquid includes 1-butyl-3-methylimidazolium tetrafluoroborate or 1-butyl-3-methylimidazolium acetate. In other examples, the complexing agent includes an organic complex such as 2,2′-bipyridyl or ethylenediaminetetraacetic acid (EDTA). In some examples, the polyol solvent includes ethylene glycol.

At 118, the first and second solutions are mixed together and stirred. At 122, the mixture is heated to a deposition temperature in the deposition temperature range described above. At 124, the substrate is immersed in the mixture or the mixture is applied to the substrate using a spin-on approach. Alternately, the order of steps 122 and 124 can be reversed and the substrate is immersed in the mixture before the mixture is heated. When the deposition period is complete as determined at 128, the substrate is removed, rinsed and dried at 130.

Referring now to FIG. 5B, another method 132 is shown that is similar to the method 100. At 134, a solution is prepared and includes the hydroxide, the polyol solvent, the metal precursor and the complexing agent. The solution is mixed together and stirred at 136. At 138, the solution is heated to the deposition temperature range and the substrate is immersed or the substrate is immersed and then the solution is heated to the deposition temperature range.

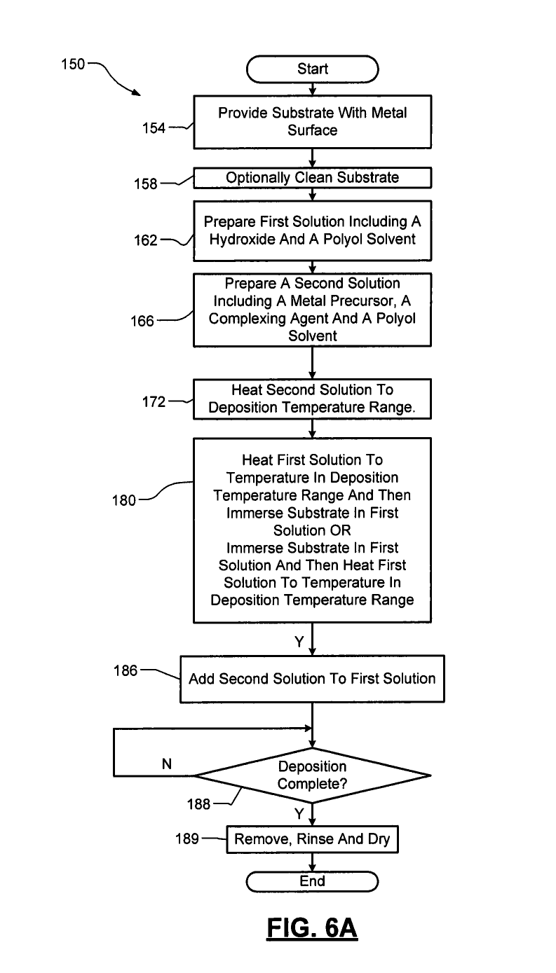

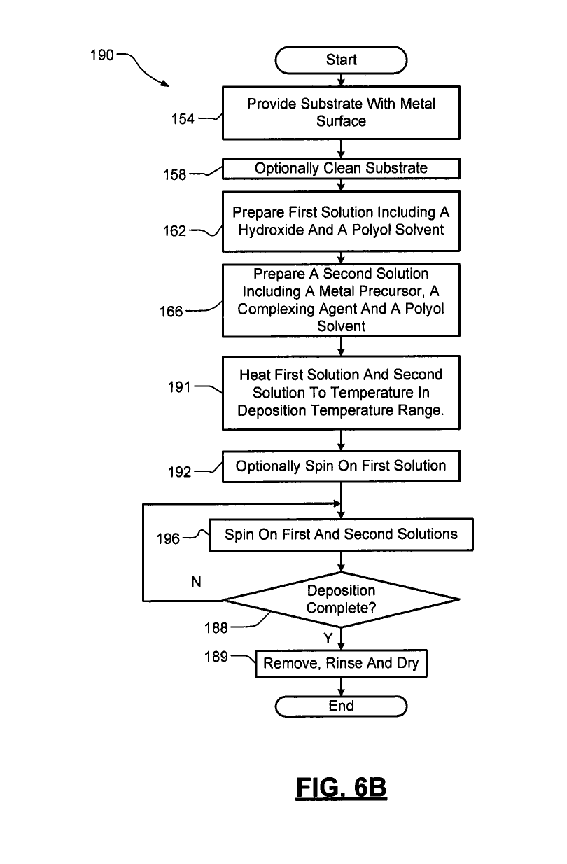

Referring now to FIG. 6A, a method 150 for depositing metal is shown. At 154, a substrate includes a metal or metal alloy surface such as a metal liner. The metal surface may be located in features such as trenches or vias. At 158, the substrate is optionally cleaned. At 162, a first solution is prepared. The first solution includes a hydroxide and polyol solvent. In some examples, the hydroxide includes sodium hydroxide (NaOH) or potassium hydroxide (KOH). In some examples, the polyol solvent includes ethylene glycol.

At 166, a second solution is prepared. The second solution includes a metal precursor, a complexing agent and a polyol solvent. In some examples, the metal precursor includes a Cu, Ru, Pt, Mn, and/or Co precursor. In some examples, the copper precursor may include copper(II) chloride (CuCl₂), copper(II) sulfate (CuSO₄), or copper(II) hydroxide (Cu(OH)₂).

In some examples, the complexing agent includes an ionic liquid or organic complex. In some examples, the ionic liquid includes 1-butyl-3-methylimidazolium tetrafluoroborate or 1-butyl-3-methylimidazolium acetate. In other examples, the complexing agent includes an organic complex such as 2,2′-bipyridyl or ethylenediaminetetraacetic acid (EDTA). In some examples, the polyol solvent includes ethylene glycol.

At 172, the second solution is heated to the deposition temperature range. At 180, the first solution is heated to the deposition temperature range and the substrate is immersed or the substrate is immersed and then the first solution is heated to the deposition temperature range. At 186, the second solution is added to the first solution.

At 188, the method determines whether the deposition period is complete. If 188 is false, the method returns to 188. If 188 is true, the method includes removing, rinsing and drying the substrate at 189.

Referring now to FIG. 6B, a method 190 for depositing metal that is similar to the method 150 is shown. At 191, the first solution and the second solution are heated to a temperature in the predetermined deposition temperate range. In some examples, the substrate is also heated to the predetermined deposition temperature range. At 192, the first solution is optionally spun on. At 196, the first and second solutions are applied to the substrate using a spin-on approach.

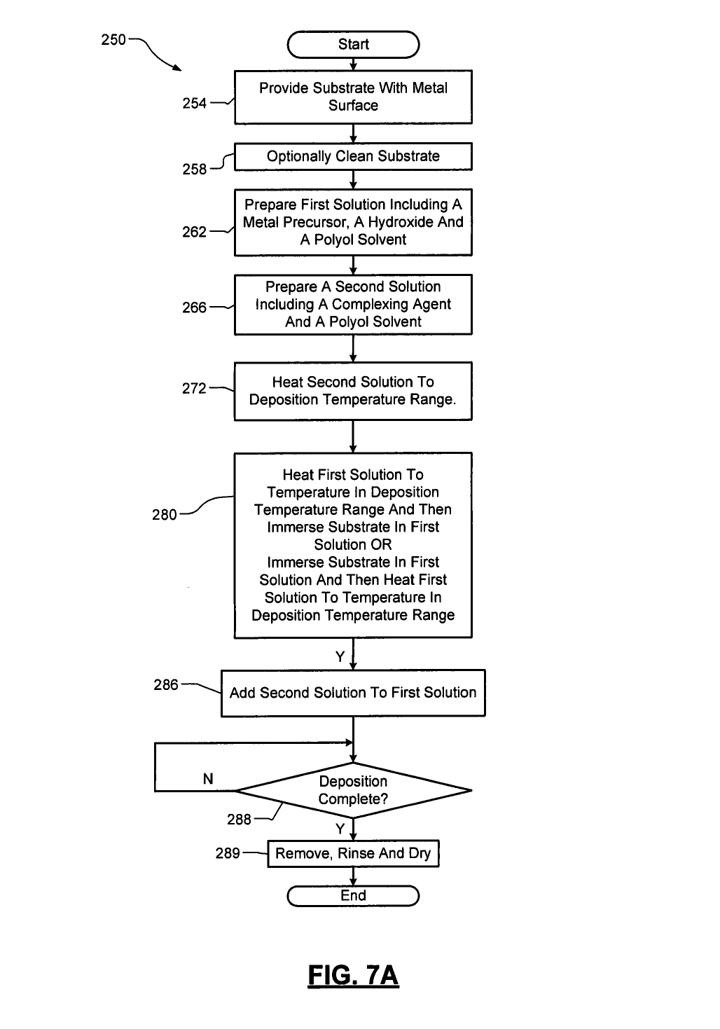

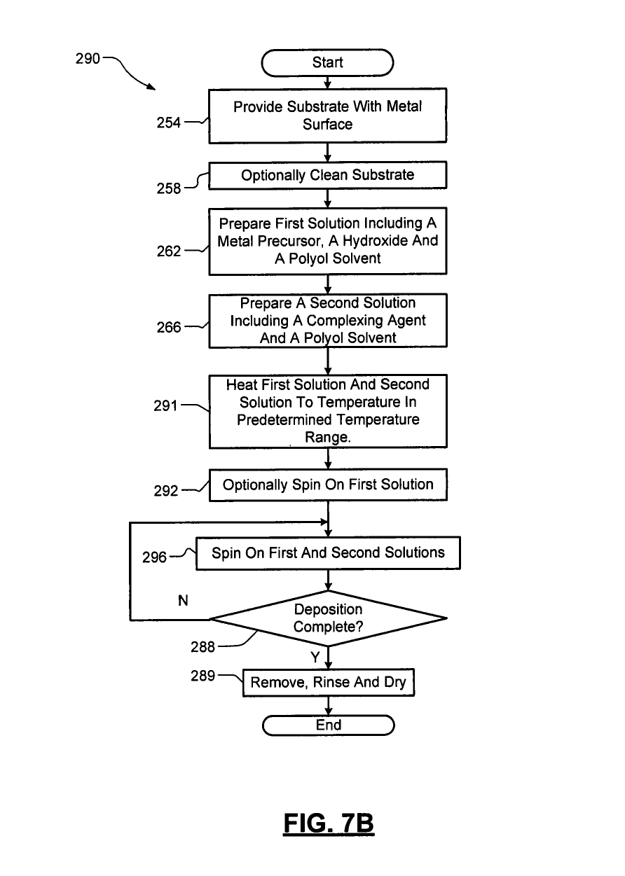

Referring now to FIG. 7A, a method 250 for depositing metal is shown. At 254, a substrate is provided with a metal or metal alloy surface such as a metal liner. The metal surface may be located in features such as trenches or vias. At 258, the substrate is optionally cleaned. At 262, a first solution is prepared. The first solution includes a metal precursor, a polyol solvent and a hydroxide. In some examples, the metal precursor includes a Cu, Ru, Pt, Mn and/or Co precursor. In some examples, the copper precursor may include copper(II) chloride (CuCl₂), copper(II) sulfate (CuSO₄), or copper(II) hydroxide (Cu(OH)₂). In some examples, the polyol solvent includes ethylene glycol. In some examples, the hydroxide includes sodium hydroxide (NaOH) or potassium hydroxide (KOH).

At 266, a second solution is prepared. The second solution includes a complexing agent and a polyol solvent. In some examples, the complexing agent includes an ionic liquid or an organic complex. In some examples, the ionic liquid includes 1-butyl-3-methylimidazolium tetrafluoroborate or 1-butyl-3-methylimidazolium acetate. In other examples, the complexing agent includes an organic complex such as 2,2′-bipyridyl or ethylenediaminetetraacetic acid (EDTA). In some examples, the polyol solvent includes ethylene glycol.

At 272, the second solution is heated to a temperature in the predetermined deposition temperature range. At 280, the first solution is heated to the deposition temperature range and the substrate is immersed or the substrate is immersed and then the first solution is heated to the deposition temperature range. At 286, the second solution is added to the first solution to initiate deposition. At 288, the method determines whether the deposition period is complete. If 288 is false, the method returns to 288. Selective deposition of metal occurs on the metal surfaces such as the metal liner. If 288 is true, the method includes removing, rinsing and drying the substrate at 289.

Referring now to FIG. 7B, a method 290 that is similar to the method 250 is shown. At 291, the first solution and the second solution are heated to a temperature in the predetermined temperate range. At 292, the first solution is optionally spun on. At 296, the first and second solutions are applied to the substrate using a spin-on approach.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method for depositing metal or metal alloy on a substrate, comprising:
preparing a mixture including a hydroxide, a polyol solvent, a metal precursor and a complexing agent, wherein the mixture does not include water;
applying the mixture to a substrate including exposed metal surfaces to selectively deposit metal onto the exposed metal surfaces of the substrate; and
heating the mixture to a predetermined deposition temperature range from 120° C. and 160° C. at least one of before or after applying the mixture to the substrate.

2. The method of claim 1, wherein preparing the mixture includes:
preparing a first solution including the hydroxide and the polyol solvent;
preparing a second solution including the metal precursor, the complexing agent and the polyol solvent; and
mixing the first solution and the second solution.

3. The method of claim 1, wherein the metal precursor includes at least one precursor selected from a group consisting of a copper precursor, a ruthenium precursor, a cobalt precursor, a platinum precursor, and a manganese precursor.

4. The method of claim 1, wherein the metal precursor is selected from a group consisting of copper(II) chloride (CuCl₂), copper(II) sulfate (CuSO₄), or copper(II) hydroxide (Cu(OH)₂).

5. The method of claim 1, wherein the hydroxide is selected from a group consisting of sodium hydroxide (NaOH) and potassium hydroxide (KOH).

6. The method of claim 1, wherein the complexing agent is selected from a group consisting of an ionic liquid and an organic complex.

7. The method of claim 6, wherein the ionic liquid is selected from a group consisting of 1-butyl-3-methylimidazolium tetrafluoroborate and 1-butyl-3-methylimidazolium acetate.

8. The method of claim 6, wherein the organic complex is selected from a group consisting of 2,2′-bipyridyl and ethylenediaminetetraacetic acid (EDTA).

9. The method of claim 1, further comprising removing the substrate from the mixture after a predetermined deposition period.

10. The method of claim 9, further comprising rinsing and drying the substrate.

11. The method of claim 10, wherein the rinsing includes rinsing the substrate with at least one of deionized water and a polyol solvent and wherein the drying includes exposing the substrate to molecular nitrogen gas.

12. The method of claim 1, wherein applying the mixture includes immersing the substrate in the mixture.

13. The method of claim 1, wherein applying the mixture includes using a spin-on approach to apply the mixture to the substrate.

14. A method for depositing metal or metal alloy on a substrate, comprising:
preparing a first solution including a hydroxide and a polyol solvent;
applying the first solution to a substrate including exposed metal surfaces;
heating the first solution to a first predetermined temperature at least one of before or after applying the solution to the substrate;
preparing a second solution including a metal precursor, a complexing agent and a polyol solvent;
heating the second solution to a second predetermined temperature; and
applying the second solution to the substrate to selectively deposit metal onto the metal surfaces of the substrate,
wherein the first predetermined temperature and the second predetermined temperature are in a range from 120° C. and 160° C.

15. The method of claim 14, wherein the metal precursor includes at least one precursor selected from a group consisting of a copper precursor, a ruthenium precursor, a platinum precursor, a cobalt precursor and a manganese precursor.

16. The method of claim 14, wherein the metal precursor is selected from a group consisting of copper(II) chloride (CuCl₂), copper(II) sulfate (CuSO₄), or copper(II) hydroxide (Cu(OH)₂).

17. The method of claim 14, wherein the hydroxide is selected from a group consisting of sodium hydroxide (NaOH) and potassium hydroxide (KOH).

18. The method of claim 14, wherein the complexing agent is selected from a group consisting of an ionic liquid and an organic complex.

19. The method of claim 18, wherein the ionic liquid is selected from a group consisting of 1-butyl-3-methylimidazolium tetrafluoroborate and 1-butyl-3-methylimidazolium acetate.

20. The method of claim 18, wherein the organic complex is selected from a group consisting of 2,2′-bipyridyl and ethylenediaminetetraacetic acid (EDTA).

21. The method of claim 14, further comprising removing the substrate after a predetermined deposition period.

22. The method of claim 21, further comprising rinsing and drying the substrate.

23. The method of claim 22, wherein the rinsing includes rinsing the substrate with at least one of deionized water and a polyol solvent and the drying includes exposing the substrate to molecular nitrogen gas.

24. The method of claim 14, wherein applying the first solution includes immersing the substrate in the first solution and applying the second solution includes adding the second solution to the first solution while the substrate is immersed in the first solution.

25. The method of claim 14, wherein applying the first solution to the substrate includes using a spin-on approach and applying the second solution to the substrate includes using the spin-on approach.

26. A method for depositing metal or metal alloy on a substrate, comprising:
preparing a first solution including a metal precursor, a hydroxide and a polyol solvent;
applying the first solution to a substrate including exposed metal surfaces;
heating the first solution to a first predetermined temperature at least one of before or after applying the first solution to the substrate;
preparing a second solution including a complexing agent and a polyol solvent;
heating the second solution to a second predetermined temperature; and
applying the second solution to the substrate to selectively deposit metal onto the exposed metal surfaces of the substrate,
wherein the first predetermined temperature and the second predetermined temperature are in a range from 120° C. and 160° C.

27. The method of claim 26, wherein the metal precursor includes at least one precursor selected from a group consisting of a copper precursor, a ruthenium precursor, a platinum precursor, a cobalt precursor and a manganese precursor.

28. The method of claim 27, wherein the metal precursor is selected from a group consisting of copper(II) chloride (CuCl₂), copper(II) sulfate (CuSO₄), or copper(II) hydroxide (Cu(OH)₂.

29. The method of claim 26, wherein the hydroxide is selected from a group consisting of sodium hydroxide (NaOH) and potassium hydroxide (KOH).

30. The method of claim 26, wherein the complexing agent is selected from a group consisting of an ionic liquid and an organic complex.

31. The method of claim 30, wherein the ionic liquid is selected from a group consisting of 1-butyl-3-methylimidazolium tetrafluoroborate and 1-butyl-3-methylimidazolium acetate.

32. The method of claim 30, wherein the organic complex is selected from a group consisting of 2,2′-bipyridyl and ethylenediaminetetraacetic acid (EDTA).

33. The method of claim 26, further comprising removing the substrate after a predetermined deposition period.

34. The method of claim 33, further comprising rinsing and drying the substrate.

35. The method of claim 34, wherein the rinsing includes rinsing the substrate with at least one of deionized water and polyol solvent and the drying includes exposing the substrate to molecular nitrogen gas.

36. The method of claim 26, wherein applying the first solution includes immersing the substrate in the first solution and applying the second solution includes mixing the second solution with the first solution while the substrate is immersed in the first solution.

37. The method of claim 26, wherein applying the first solution to the substrate includes using a spin-on approach and applying the second solution to the substrate includes using the spin-on approach.
